(19) United States
(12) Patent Application Publication
(10) Pub. No.: US 2014/0259183 A1
(43) Pub. Date: Sep. 11, 2014

(54) PORTABLE STORAGE DEVICE AND DATA SECURITY-CONTROL METHOD THEREOF

(71) Applicant: INNOSTOR TECHNOLOGY CORPORATION, Jhubei City (TW)

(72) Inventor: Chia-Huang Tsai, Jhubei City (TW)

(73) Assignee: INNOSTOR TECHNOLOGY CORPORATION, Jhubei City (TW)

(21) Appl. No.: 13/787,780

(22) Filed: Mar. 6, 2013

(51) Int. Cl. G06F 21/60

(52) U.S. Cl. CPC G06F 21/60
USPC 726/28

(57) ABSTRACT

The invention is a portable storage device and a data security-control method thereof. The portable storage device has a controller, a non-volatile memory and a communication port. The non-volatile memory and the communication port are connected to the controller. The non-volatile memory has a data storage area and a cache area. The controller executes a data caching function through the cache area to increase data accessing speed. When the communication port is connected to a host, the controller determines whether the host loads a data security-control driver. If the host does not load the data security-control driver, a permission of the host for assessing the non-volatile memory is restricted. The non-volatile memory is then protected from erroneous data accessing to assure data security.

### BACKGROUND OF THE INVENTION

1. Field of the Invention

The present invention relates to a portable storage device and a control method thereof, and more particularly to a device and a method for increasing data accessing speed and ensuring data security.

2. Description of Related Art

A portable storage device, such as a flash drive, usually uses a flash memory as a storage medium. In addition, the flash drive has a USB (universal serial bus) port as a communication interface adapted to connect to a host. As the flash memory manufacturing technology improves, the storage capacity of the flash drive is greatly expanded. In addition to having a large storage capacity, the flash drive is a plug-and-play device and hence is widely and frequently used nowadays due to the convenience in usage. As the flash drive is frequently used, the data in the storage space is repeatedly written, read and erased. As time goes, the storage space of the flash memory is randomly divided and dispersed. The accessing speed is then affected.

A cache technique can write data into the dispersed storage spaces to increase the accessing speed. However, when the portable storage device executes cache function, the portable storage device has to assure that the data is completely moved to the storage space to avoid erroneous data accessing. Therefore, accessing speed needs to be increased so as to assure further improvement of the data security and correctness.

### SUMMARY OF THE INVENTION

An objective of the invention is to provide a data security-control method of a portable storage device. The method provides a data caching function to increase data accessing speed. The method can also protect the data stored in the portable storage device from being accessed, destroyed or altered.

The method of the invention comprises the steps of:

providing a portable storage device having a controller, a non-volatile memory and a communication port, wherein the non-volatile memory and the communication port are connected to the controller, and the non-volatile memory has a data storage area and a cache area;

connecting the communication port of the portable storage device to a host; and

determining a permission for the host by the controller to access the non-volatile memory based on a data security-control driver loaded by the host.

Another method of the invention comprises the steps of:

providing a portable storage device having a controller, a non-volatile memory and a communication port, wherein the non-volatile memory and the communication port are respectively connected to the controller, and the non-volatile memory has a data storage area and a cache area;

connecting the communication port of the portable storage device to a host;

determining the host does not load a data security-control driver;

accessing the non-volatile memory of the portable storage device by the host, wherein the host executes an application program to communicating with the controller and to access the non-volatile memory; and

managing the data stored in the cache area and the data storage area by the application program.

The method of the invention is to define a cache area for rapidly accessing data. The data in the cache area is then moved to the data storage area at a proper time. In order to assure the data correctness, the host loads the data security-control driver. When the portable storage device is connected to any host, the portable storage device determines whether the host has the data security-control driver. If the host does not have the data security-control driver, the controller disables the non-volatile memory to be inaccessible for the host. Hence, the data storage area is protected from erroneous data accessing to assure the data correctness and security.

Another objective of the invention is to provide a portable storage device. The device of the invention has a data caching function for increasing accessing speed and assures the data completeness and correctness.

The portable storage device of the invention comprises:

a non-volatile memory having a data storage area and a cache area;

a controller connected to the non-volatile memory and setting a permission to the data storage area and the cache area; and

a communication port connected to the controller;

wherein the controller sets the permission of the data storage area and the cache area according to an access permission request received by the communication port.

The device mentioned above is to define a cache area for rapidly accessing data. The data in the cache area is then moved to the data storage area at a proper time. The communication port is adapted to connect to a host. When the host loads a data security-control driver, the host can send an access permission request to the portable storage device. When the portable storage device receives the access permission request, the portable storage device allows the host for accessing the non-volatile memory and the controller of the portable storage device combines partial data stored in the cache area with remaining data stored in the data storage area to make a complete data. Otherwise, if a host does not load the data security-control driver, the host will not send the access permission request to the portable storage device. As a result, the controller disables the non-volatile memory to be inaccessible for the host. The data in the non-volatile memory is protected from erroneous data accessing to assure the data correctness and security.

### BRIEF DESCRIPTION OF THE DRAWINGS

FIG. 1 is a circuit block diagram of an embodiment of the portable storage device of the invention;

FIG. 2 is a circuit block diagram of the portable storage device connected to a host; and

FIG. 3 is a flow chart of an embodiment of the method of the invention.

### DETAILED DESCRIPTION OF THE PREFERRED EMBODIMENT

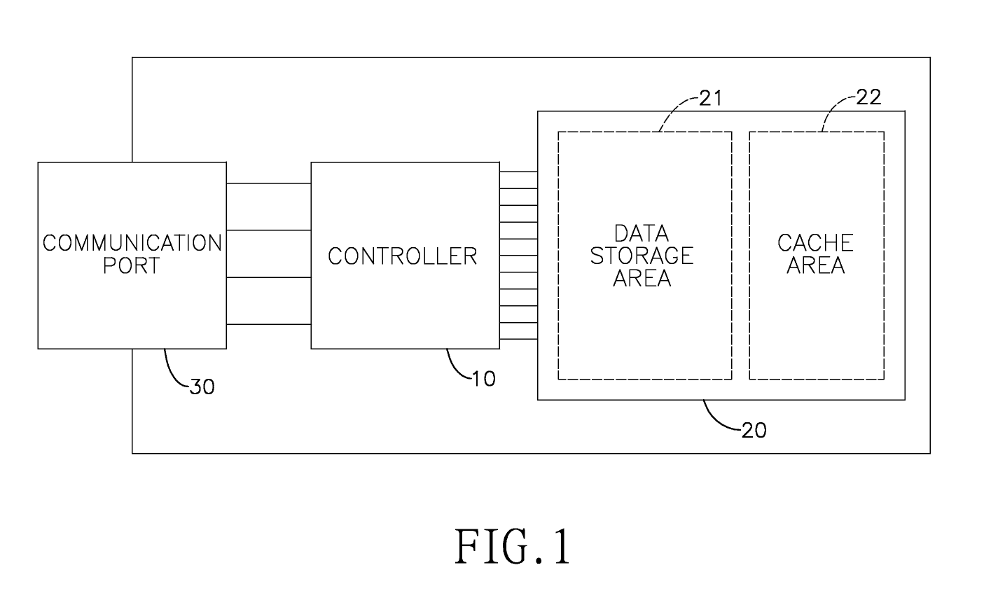

With reference to FIG. 1, a portable storage device of the invention comprises a controller 10, a non-volatile memory 20 and a communication port 30.

The controller 10 has multiple data pins, multiple address pins and multiple I/O (input and output) pins. The data pins and the address pins are connected to the non-volatile memory 20. The I/O pins are connected to the communication port 30. The communication port 30 can be, but is not limited to, a USB port.

The non-volatile memory 20 has a data storage area 21 and a cache area 22. A storage capacity of the data storage area 21 is larger than a storage capacity of the cache area 22. The data storage area 21 is for storing data. The cache area 22 is inaccessible for data accessing by a user. The cache area 22 cooperates with the controller 10 for executing a data caching function.

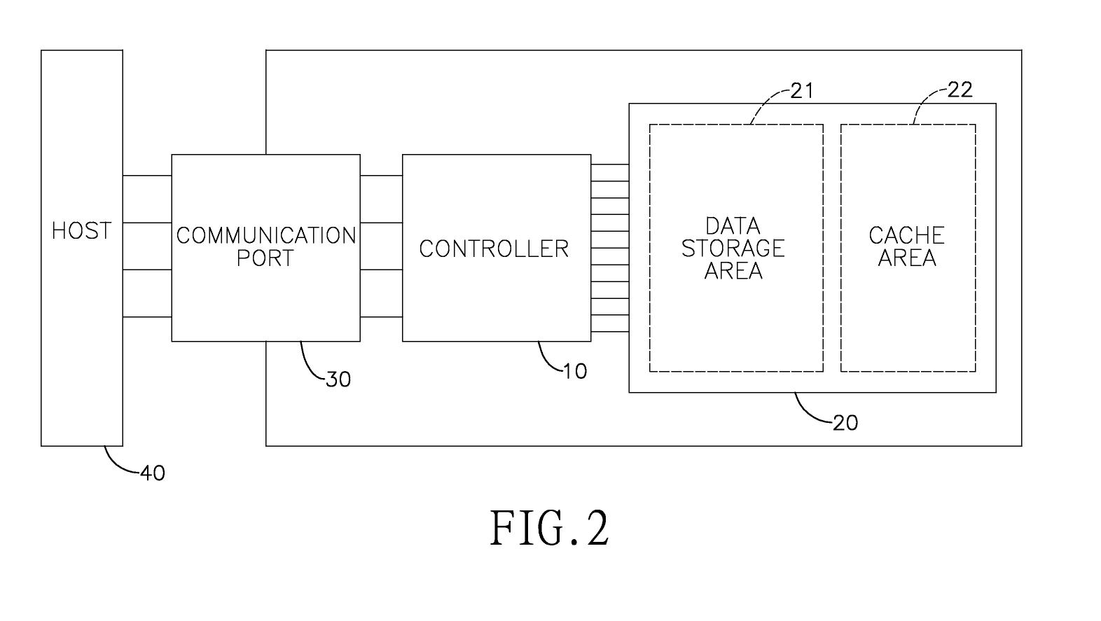

With reference to FIG. 2, the communication port 30 of the portable storage device is adapted to connect to a host 40, wherein the host 40 loads a data security-control driver for recognizing the data caching function as mentioned above. When the host 40 writes data into the non-volatile memory 20, the controller 10 firstly receives the data from the host 40 and writes the data into the cache area 22. The cache area 22 provides continuous storing space for increasing data accessing speed. When the host 40 stops writing data, the controller 10 moves the data from the cache area 22 to the data storage area 21. Because the controller 10 does not immediately move the whole data from the cache area 22 to the data storage area 21, the data of one file may be separated into two parts at one moment. One part of the file may be stored in the cache area 22 and the other part of the file may be stored in the data storage area 21. The situation may occur when the portable storage device is just newly disconnected from the host 40.

When the portable storage device is connected to a host without loading the data security-control driver, the host cannot execute the data caching function with the cache area 22. The host can only read the incomplete data stored in the data storage area 21. If the host still writes data into the data storage area 21, a data error will occur.

In order to ensure the correctness and completeness of the stored data, a permission of a host 40 without loading the data security-control driver is restricted, such that the data stored in the data storage area 21 is prevented from being accessed, destroyed or altered.

The controller 10 executes a permission control process. When the communication port 30 of the portable storage device is connected to a host 40, the controller 10 determines whether the host loads the data security-control driver. When the host 40 loads the data security-control driver, the host 40 sends an access permission request to the controller 10. The controller 10 determines whether the host 40 loads the data security-control driver by determining whether the communication port 30 receives the access permission request from the host 40. If the portable storage device does not receive the access permission request after the portable storage device is connected to the host 40, the portable storage device determines that the host 40 does not load the data security-control driver. The controller 10 then disables the non-volatile memory 20 to be inaccessible for the host 40. Alternatively, the controller 10 can set the non-volatile memory 20 as a read-only memory. The host 40 can only read the data storage area 21 but cannot write data into the data storage area 21. The data stored in the data storage area 21 is then prevented from being accessed, destroyed or altered.

Otherwise, when the controller 10 determines that the host 40 loads the data security-control driver by receiving the access permission request, the controller 10 enables the non-volatile memory 20 to be accessible. The data information is completely revealed from the data storage area 21 and the cache area 22. The host 40 then can execute an application program to read the data information of the data storage area 21 and the cache area 22 and can access the data of the non-volatile memory 20.

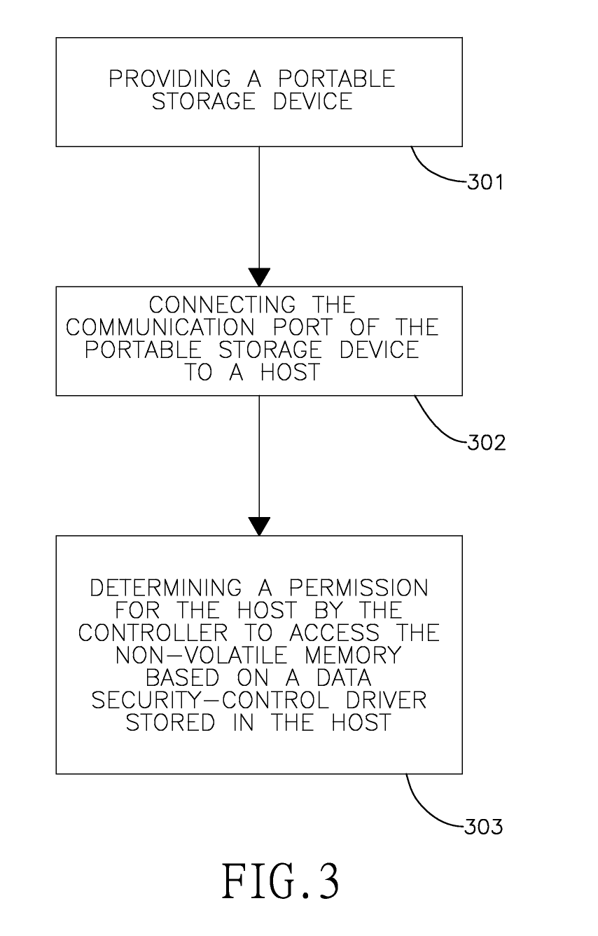

With reference to FIG. 3, the data security-control method of the invention includes the steps of:

providing a portable storage device having a data caching function (step 301);

connecting the portable storage device to a host 40 (step 302);

determining a permission for the host 40 by the controller 10 to access the non-volatile memory 20 based on a data security-control driver loaded by the host 40 (step 303).

When the host 40 stores the data security-control driver, the controller 10 enables the non-volatile memory 20 to be accessible.

The host 40 can load a root application program with a complete access permission if the host 40 does not load the data security-control driver. The root application program communicates with the controller 10. The root application program can provide function similar to a file administrator, or the root application program can be other application programs that can manage data stored in the cache area 22 and the data storage area 21 of the non-volatile memory 20. When the portable storage device is connected to the host 40, a user can operate the host 40 to execute the application program, such that the host 40 can access the data of the portable storage device. In other words, the data stored in the non-volatile memory 20 can be accessed only by the root application program of the host 40. Other application programs excluding the root application program are still prohibited from accessing data of the non-volatile memory 20.

In conclusion, the invention mainly divides the storage space of the non-volatile memory 20 into a data storage area 21 and a cache area 22. In cooperation with the data security-control driver of the host 40, the accessing speed is increased by executing the data caching function.

In order to prevent the host 40 from writing data into the cache area 22 when the data in the cache area 22 is not yet completely moved to the data storage area 21, the controller 10 determines whether the host 40 stores the data security-control driver. When the host 40 loads the data security-control driver, the controller 10 enables the non-volatile memory 20 to be accessible, and the host 40 can access the non-volatile memory 20. If the host 40 does not load the data security-control driver, the permission of the host 40 is restricted. The data in the data storage area 21 is prevented from being accessed, destroyed or altered. The correctness and completeness of the stored data are assured.

What is claimed is:

1. A data security-control method of a portable storage device, the method comprising the steps of:
providing a portable storage device having a controller, a non-volatile memory and a communication port, wherein the non-volatile memory and the communication port are connected to the controller, and the non-volatile memory has a data storage area and a cache area;
connecting the communication port of the portable storage device to a host; and
determining a permission for the host by the controller to access the non-volatile memory based on a data security-control driver loaded by the host.

2. The method as claimed in claim 1, wherein when the host loads the data security-control driver, the controller enables the non-volatile memory to be accessible, such that data information is completely revealed from the data storage area and the cache area.

3. The method as claimed in claim 1, wherein the controller executes a data caching function using the cache area to increase data accessing speed.

4. The method as claimed in claim 2, wherein the controller executes a data caching function using the cache area to increase data accessing speed.

5. The method as claimed in claim 3, wherein when the controller determines that the host does not load the data security-control driver, the controller disables the non-volatile memory to be inaccessible for the host.

6. The method as claimed in claim 4, wherein when the controller determines that the host does not load the data security-control driver, the controller disables the non-volatile memory to be inaccessible for the host.

7. The method as claimed in claim 3, wherein when the controller determines that the host does not load the data security-control driver, the controller sets the non-volatile memory as a read-only memory.

8. The method as claimed in claim 4, wherein when the controller determines that the host does not load the data security-control driver, the controller sets the non-volatile memory as a read-only memory.

9. A data security-control method of a portable storage device, the method comprising the steps of:
providing a portable storage device having a controller, a non-volatile memory and a communication port, wherein the non-volatile memory and the communication port are respectively connected to the controller, and the non-volatile memory has a data storage area and a cache area;
connecting the communication port of the portable storage device to a host;
determining the host does not load a data security-control driver;
accessing the non-volatile memory of the portable storage device by the host, wherein the host executes an application program to communicating with the controller and to access the non-volatile memory; and
managing the data stored in the cache area and the data storage area by the application program.

10. A portable storage device comprising:
a non-volatile memory having a data storage area and a cache area;
a controller connected to the non-volatile memory and setting a permission to the data storage area and the cache area; and
a communication port connected to the controller;
wherein the controller sets the permission of the data storage area and the cache area according to an access permission request received by the communication port.

11. The device as claimed in claim 10, wherein when the controller does not receive the access permission request, the controller disables the non-volatile memory to be inaccessible.

12. The device as claimed in claim 10, wherein when the controller does not receive the access permission request, the controller sets the non-volatile memory as a read-only memory.

13. The device as claimed in claim 10, wherein the communication port is a USB port.

14. The device as claimed in claim 11, wherein the communication port is a USB port.

15. The device as claimed in claim 12, wherein the communication port is a USB port.
